(19) United States
(12) Patent Application Publication
(10) Pub. No.: US 2024/0373402 A1
(43) Pub. Date: Nov. 7, 2024

(54) COMMUNICATION METHOD AND APPARATUS, TERMINAL AND NETWORK DEVICE

(71) Applicant: SPREADTRUM SEMICONDUCTOR (NANJING) CO., LTD., Nanjing, Jiangsu (CN)

(72) Inventors: Zhenzhu LEI, Nanjing (CN); Huayu ZHOU, Nanjing (CN)

(21) Appl. No.: 18/683,299

(22) PCT Filed: Aug. 16, 2022
(86) PCT No.: PCT/CN2022/112756

§ 371 Date: Feb. 13, 2024

(30) Foreign Application Priority Data
Aug. 19, 2021 (CN) 202110957306.6

(51) Int. Cl. H04W 68/02; H04W 76/27; H04W 76/28

(52) U.S. Cl. CPC H04W 68/02; H04W 76/27; H04W 76/28

(57) ABSTRACT

A communication method and apparatus, a terminal, and a network device are provided. The method includes the following. A network device sends configuration information, where the configuration information is used for configuring at least one first resource. A terminal receives the configuration information. The network device sends a first signal on the at least one first resource. The terminal receives the first signal on the at least one first resource. The terminal performs state transition of the terminal and/or receives paging related information according to a signal detection result of the first signal, where the paging related information includes paging early indication (PEI) information and/or paging downlink control information (DCI).

### CROSS-REFERENCE TO RELATED DISCLOSURE(S)

The application is a National Stage of International Application No. PCT/CN2022/112756, filed Aug. 16, 2022, which claims priority to Chinese Patent Application No. 202110957306.6, filed Aug. 19, 2021, the entire disclosure of which are incorporated herein by reference.

### TECHNICAL FIELD

This disclosure relates to the field of communication technology, and more particularly, to a communication method and apparatus, a terminal, and a network device.

### BACKGROUND

With continuous evolution of standard protocols formulated by the 3^{rd} generation partnership project (3GPP), in order to prolong the battery life of a terminal to a duration of several weeks or even several years, 3GPP is currently discussing issues related to introducing a low power wake-up signal (LP-WUS) and using the LP-WUS to wake up the terminal to perform state transition.

With continuous movement of the terminal, when the terminal moves to beyond the coverage of the LP-WUS, since a network is unable to know that the terminal is located in an area where the LP-WUS cannot be monitored, the network device will still use the LP-WUS to consistently wake up the terminal to perform state transition, thus causing additional overhead of network resources; since the LP-WUS cannot be monitored by the terminal beyond the coverage of the LP-WUS, the terminal is unable to perform state transition based on the LP-WUS, and is unable to perform communication operations normally or update related parameters. Therefore, for the case where the terminal is unable to receive the LP-WUS to perform state transition, how to implement state transition of the terminal and/or perform communication operations normally/update related parameters needs further study.

### SUMMARY

The disclosure provides a communication method and apparatus, a terminal, and a network device. By introducing a first signal, a terminal device can perform state transition of the terminal and/or receive paging related information based on a signal measurement result of the first signal, which is conducive to lowering the probability that the terminal is unable to communicate normally in case a low power wake-up signal (LP-WUS) cannot be monitored.

In a first aspect, a communication method according to embodiments of the disclosure is provided. The method specifically includes the following. A terminal obtains configuration information, where the configuration information is used for configuring at least one first resource. The terminal receives a first signal on the at least one first resource. The terminal performs state transition of the terminal and/or receives paging related information according to a signal measurement result of the first signal, where the paging related information includes paging early indication (PEI) information and/or paging downlink control information (DCI).

In embodiments of the disclosure, since a network device may configure the at least one first resource for the terminal, the terminal may receive the first signal on the at least one first resource. As such, the terminal can determine, based on the measurement result of the first signal, whether to perform state transition and/or receive the paging related information, thereby lowering the probability that the terminal is unable to perform state transition, communicate normally, or update related parameters in case an LP-WUS cannot be received.

Further, based on the signal measurement result of the first signal, the terminal enters a corresponding state. That is, the terminal monitors an LP-WUS only when located in an area where an LP-WUS can be monitored, which is conducive to lowering the probability that the terminal monitors a LP-WUS when located in an area where an LP-WUS cannot be monitored, thereby reducing power consumption of the terminal and improving reliability of communication.

In a second aspect, a communication method according to embodiments of the disclosure is provided. The method includes the following. A network device sends configuration information, where the configuration information is used for configuring at least one first resource. The network device sends a first signal on the at least one first resource.

In a third aspect, a communication apparatus according to embodiments of the disclosure is provided. The apparatus includes a processing unit and a communication unit. The processing unit is configured to: obtain configuration information and receive a first signal on at least one first resource via the communication unit, where the configuration information is used for configuring the at least one first resource; and perform state transition of the apparatus and/or receive paging related information according to a signal measurement result of the first signal, where the paging related information includes PEI information and/or paging DCI.

In a fourth aspect, a communication apparatus according to embodiments of the disclosure is provided. The apparatus includes a processing unit and a communication unit. The processing unit is configured to: send configuration information via the communication unit, where the configuration information is used for configuring at least one first resource; and send a first signal on the at least one first resource via the communication unit.

In a fifth aspect, a terminal according to embodiments of the disclosure is provided. The terminal includes a processor, a memory, a communication interface, and at least one program. The at least one program is stored in the memory. The processor, when executing the at least one program, enables the terminal to perform the method described in the first aspect.

In a sixth aspect, a network device according to embodiments of the disclosure is provided. The network device includes a processor, a memory, a communication interface, and at least one program, the at least one program is stored in the memory. The processor, when executing the at least one program, enables the network device to perform the method described in the second aspect.

In a seventh aspect, a computer-readable storage medium according to embodiments of the disclosure is provided. The computer-readable storage medium is configured to store computer programs for electronic data interchange (EDI). The computer programs, when executed, are operable to perform the method described in the first aspect or the second aspect.

In an eighth aspect, a computer program according to embodiments of the disclosure is provided. The computer program includes instructions for implementing some or all of the steps described in the first aspect or the second aspect. For example, the computer program may be a software installation package.

### BRIEF DESCRIPTION OF THE DRAWINGS

To describe technical solutions of embodiments of the disclosure more clearly, the following will give a brief introduction to the accompanying drawings used for describing the embodiments or the related art.

FIG. 1A is a schematic structural diagram of a terminal according to embodiments of the disclosure.

FIG. 1B is a schematic architectural diagram of a wireless communication system according to embodiments of the disclosure.

FIG. 2 is a schematic flowchart of a communication method according to embodiments of the disclosure.

FIG. 3 is a schematic diagram illustrating position distribution of first resources according to embodiments of the disclosure.

FIG. 4 is a schematic diagram illustrating position distribution of first resources and second resources according to embodiments of the disclosure.

FIG. 5 is a schematic diagram illustrating position distribution of paging occasions (PO) in an extended idle mode discontinuous reception (eDRX) mechanism according to embodiments of the disclosure.

FIG. 6 is a schematic diagram illustrating position distribution of POs in a DRX mechanism according to embodiments of the disclosure.

FIG. 7 is a block diagram illustrating functional units of a communication apparatus according to embodiments of the disclosure.

FIG. 8 is a block diagram illustrating functional units of another communication apparatus according to embodiments of the disclosure.

FIG. 9 is a schematic structural diagram of a terminal according to embodiments of the disclosure.

FIG. 10 is a schematic structural diagram of a network device according to embodiments of the disclosure.

### DETAILED DESCRIPTION

The terms “first”, “second”, and the like in the specification and claims of the disclosure, and above accompanying drawings are used to distinguish different objects, rather than describe a particular order. In addition, the terms “include”, “comprise”, and “have” as well as variations thereof are intended to cover non-exclusive inclusion. For example, a process, method, software, product, or device including a series of steps or units is not limited to the listed steps or units, and instead, it can optionally include other steps or units that are not listed or other steps or units inherent to the process, method, product, or device.

The term “embodiment” referred to in embodiments of the disclosure means that a particular feature, structure, or characteristic described in conjunction with the embodiment may be contained in at least one embodiment of the disclosure. The phrase appearing in various places in the specification does not necessarily refer to the same embodiment, nor does it refer to an independent or alternative embodiment that is mutually exclusive with other embodiments. It is explicitly and implicitly understood by those skilled in the art that an embodiment described herein may be combined with other embodiments.

It should be noted that, the term “connection” appearing in the embodiments of the disclosure refers to various connection manners, such as direct connection or indirect connection, so as to implement communication between devices, which is not limited herein. The terms “network” and “system” in the embodiments of the disclosure may refer to the same concept, and a communication system is a communication network. The “equal to” involved in the embodiments of the disclosure can be used together with “greater than”, and is applicable to technical solutions used in case of “greater than”; and may also be used together with “less than”, and is applicable to technical solutions used in case of “less than”. It should be noted that, when used together with “greater than”, “equal to” is not used together with “less than”; when used together with “less than”, “equal to” is not used together with “greater than”.

The technical solutions of the embodiments of the disclosure may be applied to various wireless communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication System (UMTS), a wireless local area network (WLAN), a wireless fidelity (WiFi), a 6^{th}-generation (6G) communication system, or other communication systems.

It should be noted that, a conventional wireless communication system generally supports a limited quantity of connections and therefore is easy to implement. However, with development of communication technology, a wireless communication system will not only support a conventional wireless communication system but also support, for example, device to device (D2D) communication, machine to machine (M2M) communication, machine type communication (MTC), vehicle to vehicle (V2V) communication, vehicle to everything (V2X) communication, narrowband internet of things (NB-IoT) communication, etc. Therefore, the technical solutions of the embodiments of the disclosure can also be applied to these wireless communication systems.

In addition, the technical solutions of the embodiments of the disclosure may be applied to a beamforming scenario, a carrier aggregation (CA) scenario, a dual connectivity (DC) scenario, or a standalone (SA) deployment scenario, etc.

In the embodiments of the disclosure, a spectrum used for communication between a terminal and a network device, or a spectrum used for communication between terminals may be a licensed spectrum, or may be an unlicensed spectrum, which is not limited herein. It should be noted that, an unlicensed spectrum may be understood as a shared spectrum, and a licensed spectrum may be understood as a non-shared spectrum.

Since various embodiments of the disclosure are described in connection with a terminal and a network device, the terminal and the network device involved will be described in detail below.

Specifically, the terminal may be a user equipment (UE), a remote UE, a relay UE, an access terminal, a subscriber unit, a subscriber station, a mobile station, a remote station, a mobile device, a user terminal, a smart terminal, a wireless communication device, a user agent, or a user apparatus. It should be noted that, a relay device is a terminal capable of providing a relay forwarding service for other terminals (including a remote terminal). In addition, the terminal may also be a cellular radio telephone, a cordless telephone, a session initiation protocol (SIP) telephone, a wireless local loop (WLL) station, a personal digital assistant (PDA), various devices having wireless communication functions such as a handheld device, a computing device or other processing devices coupled with a wireless modem, an in-vehicle device, a wearable device, a terminal in a next-generation communication system (such as an NR communication system, a 6G communication system), or a terminal in a future evolved public land mobile network (PLMN), etc., which is not limited herein.

The terminal may be deployed on land, which includes indoor or outdoor, handheld, wearable, or in-vehicle. The terminal may also be deployed on water (such as ships, etc.). The terminal may also be deployed in the air (such as airplanes, balloons, satellites, etc.).

In addition, the terminal may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

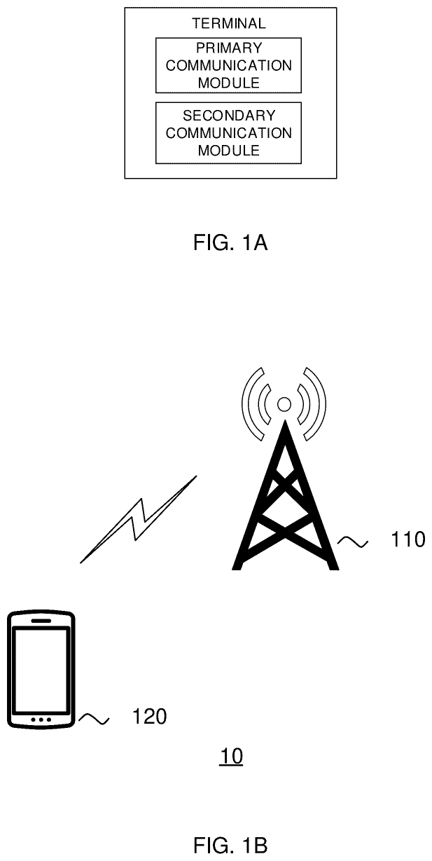

In some embodiments, the structure of the terminal may be that as illustrated in FIG. 1A, including a primary communication module and a secondary communication module.

When the terminal is in a power-off state or a flight mode, the primary communication module is in an off state, and the secondary communication module is in an on state to receive a first signal or monitor a low power wake-up signal (LP-WUS). When an LP-WUS is monitored by the secondary communication module of the terminal, that is, when the terminal transitions to a radio resouce control (RRC)_IDLE/RRC_INACTIVE/RRC_CONNECT state from a power-off state/a flight mode state, the terminal enables the primary communication module, and the secondary communication module may be enabled or disabled.

When the terminal is in a non-power-off state or a non-flight state and the terminal is powered on, the primary communication module is in an on state, and the secondary communication module may be in an on state or an off state.

In addition, when a terminal is in a deep sleep state, the terminal may include only a primary communication module, and receive a first signal or monitor an LP-WUS via the primary communication module. Alternatively, the terminal may include a primary communication module and a secondary communication module, and receive a first signal or monitor an LP-WUS via the secondary communication module, the details thereof are the same as the foregoing elaborations and will not be elaborated again herein.

Specifically, the network device may be a device for communicating with the terminal, and is responsible for radio resource management (RRM), quality of service (QOS) management, data compression and encryption, and data transmission and reception at an air-interface side. The network device may be a base station (BS) in a communication system or a device deployed on a radio access network (RAN) for providing wireless communication functions, for example, a base transceiver station (BTS) in a GSM or CDMA communication system, a node B (NB) in a WCDMA communication system, and an evolutional node B (eNB or eNodeB) in an LTE communication system, a next generation evolved node B (ng-eNB) in an NR communication system, a next generation node B (gNB) in an NR communication system, a master node (MN) in a DC architecture, a secondary node (SN) in a DC architecture, etc, which is not limited herein.

In addition, the network device may also be other devices in a core network (CN), such as an access and mobility management function (AMF), a user plane function (UPF), etc., or may be an access point (AP) in a WLAN, a relay station, a communication device in a future evolved PLMN, a communication device in an NTN network, etc.

Exemplarily, the network device may include an apparatus, such as a system-on-chip (SOC), that can provide wireless communication functions for the terminal. Exemplarily, the SOC may include a chip, and may further include other discrete devices.

In addition, in some embodiments of the disclosure, the network device may communicate with an internet protocol (IP) network, for example, the Internet, a private IP network, or other data networks.

In some network deployments, the network device may be an independent node so as to implement all functions of the base station, and may include a centralized unit (CU) and a distributed unit (DU), such as a gNB-CU and a gNB-DU. The network device may further include an active antenna unit (AAU). The CU can implement some functions of the network device, and the DU can also implement some other functions of the network device. For example, the CU is responsible for processing non-real-time protocols and services, and implements functions of an RRC layer, functions of a service data adaptation protocol (SDAP) layer, and functions of a packet data convergence protocol (PDCP) layer. The DU is responsible for processing physical (PHY) layer protocols and real-time services, and implements functions of a radio link control (RLC) layer, functions of a media access control (MAC) layer, and functions of a PHY layer. In addition, the AAU can implement some PHY layer processing functions, radio frequency processing functions, and active-antenna related functions. Since RRC layer information will eventually become PHY layer information, or be transformed from PHY layer information, in such network deployment, it may be considered that higher layer signaling, such as RRC layer signaling, is transmitted by the DU, or transmitted by the DU and the AAU. It can be understood that, the network device may include at least one of the CU, the DU, or the AAU. In addition, the CU may be categorized into a network device in a RAN, or may be categorized into a network device in a CN, and the disclosure is not limited in this regard.

In the embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

Specifically, the network device may provide communication service for a terminal within a coverage of a cell, where the cell may include a macro cell, a small cell, a metro cell, a micro cell, a pico cell, a femto cell, and the like.

The wireless communication system according to embodiments of the disclosure will be exemplified below.

Exemplarily, a network architecture of a wireless communication system according to embodiments of the disclosure is illustrated FIG. 1B. As illustrated FIG. 1B, the wireless communication system 10 may include a network device 110 and a terminal 120. The network device 110 and the terminal 120 may communicate in a wireless manner.

FIG. 1B is only an example of the network architecture of the wireless communication system, and does not constitute limitation on the network architecture of the communication system in embodiments of the disclosure. For example, in embodiments of the disclosure, the wireless communication system may further include a server or other devices. For another example, in embodiments of the disclosure, the wireless communication system may include multiple network devices and/or multiple terminal devices.

Firstly, some terms involved in the embodiments of the disclosure will be explained to facilitate understanding of those skilled in the art.

### 1. Paging Message

The network device may send a paging message to the terminal at a paging occasion (PO), to notify the terminal to perform corresponding operations or update related parameters. The terminal in an RRC_CONNECTED state can determine, by decoding the paging message, whether a current system message has changed. If the terminal detects that the system message has changed, the terminal will re-interpret the system message. The terminal in an RRC_IDLE state or in an RRC_INACTIVE state can know not only whether the current system message has changed, but also whether there is currently an incoming call request. Once an incoming call is detected, the terminal will trigger a random access procedure.

When the terminal is in an RRC_IDLE state, an RRC_INACTIVE state, or an RRC_CONNECTED state, the terminal may determine, according to the paging message, whether to receive an earthquake and tsunami warning system (ETWS) notification or a commercial mobile alert system (CMAS) notification.

As can be seen, the paging message has the following functions: (1) sending an incoming call request to the terminal in an RRC_IDLE state; (2) notifying the terminal in an RRC_IDLE state, in an RRC_INACTIVE state, or in an RRC_CONNECTED state that system information has changed; (3) instructing the terminal to start receiving an ETWS primary notification and/or an ETWS secondary notification; and instructing the terminal to start receiving a CMAS notification.

In addition, before monitoring the paging message, the terminal needs to complete time-frequency synchronization and automatic gain control (AGC) adjustment by using a reference signal (RS) such as a synchronization signal block (SSB).

### 2. Paging Cycle, Paging Frame (PF), and PO

The terminal in an RRC_IDLE state or in an RRC_INACTIVE state may use a discontinuous reception (DRX) mechanism to receive a paging message, so as to reduce power consumption. A paging cycle may also be referred to as a DRX cycle.

A DRX cycle may have at least one PF, and each PF may correspond to at least one PO. A PF may be a radio frame or a system frame. A PO can include multiple physical downlink control channel (PDCCH) monitoring occasions, and can consist of multiple subframes, multiple time slots (also referred to as “slots”), or multiple orthogonal frequency division multiplexing (OFDM) symbols.

In short, the terminal can monitor one PO corresponding to the terminal per paging cycle (or DRX cycle) in order to monitor whether there is paging downlink control information (DCI), a paging message, etc.

### 3. Wake-Up Signal (WUS)

In some wireless communication networks (such as IoT), the probability that a network pages the terminal is low, and as a result, the terminal does not have to monitor paging DCI at a PO(s) in some DRX cycle(s). Therefore, in order to further reduce power consumption of the terminal, a WUS mechanism is introduced in a standard protocol formulated by the 3rd generation partnership project (3GPP), that is, each PO is associated with one WUS, and a position for receiving a WUS is before a PO associated with WUS.

If the terminal is in an RRC_IDLE state or in an RRC_INACTIVE state, the network device may send a WUS to the terminal before the terminal monitors a PO, and then, the terminal may determine, according to the WUS, whether to monitor a PO associated with the WUS, which can prevent the terminal from always monitoring a PO corresponding to the terminal in a paging cycle, thereby reducing power consumption of the terminal.

### 4. Paging Early Indication (PEI)

In order to reduce power consumption of the terminal, in an RRC idle state or an RRC inactive state, each PO is associated with one PEI, and a position for receiving a PEI is before a PO associated with the PEI. Before monitoring a PO, the terminal needs to receive a PEI associated with the PO, and determine, according to the PEI, whether to monitor the PO, thereby reducing power consumption. The PEI may be DCI, a sequence, or the like.

In addition, if a UE uses an extended idle mode DRX (eDRX) mechanism to receive a paging message, each eDRX cycle is configured with a paging time window (PTW). The terminal monitors a paging PDCCH with a DRX cycle (the DRX cycle is short, and it can be considered that the terminal does not sleep and can always be reached) within a PTW so as to receive downlink data, while the terminal is in a sleep state for the rest of the time. In an eDRX mechanism, one PEI may be associated with (or correspond to) multiple POs (supposing m POs). If a PEI is monitored by the terminal, the terminal determines, according to an indication of the PEI, whether to monitor m POs associated with the PEI.

The PEI may carry subgrouping information, where the subgrouping information may indicate which terminal subgroups are to be woken up (terminals associated with the same PO can be divided into multiple terminal subgroups). Therefore, the terminal may determine whether to wake up according to a PEI corresponding to a terminal subgroup that the terminal belongs to.

To summarize, the WUS may indicate whether the terminal needs to monitor a PO corresponding to the WUS, so as to reduce power consumption of the terminal. In addition, by monitoring a PO or a PEI, the terminal can receive a paging DCI or a paging message, etc.

Embodiments of the disclosure provide a communication method. By introducing a first signal, a terminal can perform state transition and/or receive paging related information according to a signal measurement result of the first signal, which is conducive to lowering the probability that the terminal is unable to perform state transition, communicate normally, or update related parameters, etc. in case a low power signal cannot be received by the terminal.

The communication method according to embodiments of the disclosure will be described in detail below with reference to the accompanying drawings.

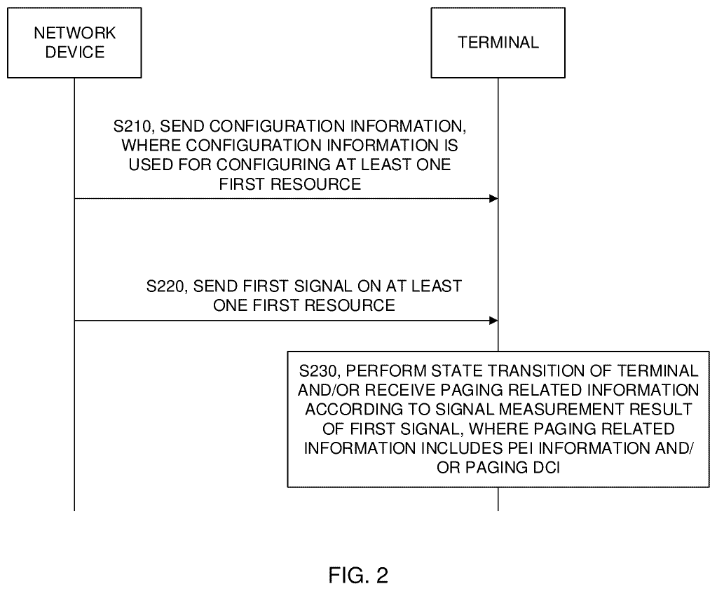

FIG. 2 is a schematic flowchart of a communication method according to embodiments of the disclosure. The method specifically includes the following steps.

S210, a network device sends configuration information, where the configuration information may be used for configuring at least one first resource. Accordingly, a terminal receives the configuration information.

Further, in some embodiments, the terminal determines the at least one first resource according to the configuration information.

It should be noted that, “the configuration information is used for configuring the at least one first resource” may mean that the configuration information indicates the at least one first resource.

In embodiments of the disclosure, the network device may send the configuration information periodically and/or after being triggered by an event. Accordingly, the terminal may receive the configuration information periodically and/or after being triggered by an event.

S220, the network device sends a first signal on the at least one first resource. Accordingly, the terminal receives the first signal on the at least one first resource.

Exemplarily, “the terminal receives the first signal on the first resource” may mean that the terminal detects the first signal on the first resource.

S230, the terminal transitions a state of the terminal and/or receives paging related information according to a signal measurement result(s) of the first signal, where the paging related information includes PEI information and/or paging DCI.

The signal measurement result of the first signal indicates a channel quality, a received quality of the first signal, or a received strength of the first signal. In some embodiments, the signal measurement result may be represented by one or more of the following parameters: a channel quality measurement parameter (such as a signal-to-interference-plus-noise ratio (SINR)), a signal received power (SRP), a signal received quality (SRQ), or a received signal strength indicator (RSSI).

In embodiments of the disclosure, the network device can configure the at least one first resource for the terminal, such that the terminal can receive the first signal on the at least one first resource. As such, the terminal determines, based on the signal measurement result of the first signal, whether to perform state transition and/or receive the paging related information, which is conducive to lowering the probability that the terminal is unable to perform state transition, communicate normally, or update related parameters in case a low power signal cannot be received by the terminal, thereby improving robustness and stability of system communication.

In some embodiments, “the network device sends the first signal on the at least one first resource” may mean that the network device sends the first signal on each of the at least one first resource. Exemplarily, two adjacent first resources in the at least one first resource have the same interval in time domain. In this case, the interval between two adjacent first resources in time domain is a period of the first resource, that is, the network device sends the first signal periodically, and accordingly, the terminal receives or detects the first signal periodically.

Taking one first resource as an example, the terminal may obtain the signal measurement result of the first signal through measurement on the first resource. For example, the terminal obtains the signal measurement result of the first signal by detecting a channel quality on the first resource. In this case, the signal measurement result of the first signal may be represented by a parameter regarding channel quality, such as an SINR. For another example, the terminal obtains the signal measurement result of the first signal by detecting a signal received quality on the first resource. In this case, the signal measurement result of the first signal may be represented by a parameter indicative of signal quality, such as an SRQ. For another example, the terminal obtains the signal measurement result of the first signal by detecting a signal received strength on the first resource. In this case, the signal measurement result of the first signal may be represented by a parameter indicative of signal strength, such as an SRP.

Exemplarily, in embodiments of the disclosure, the first signal may be an LP-WUS or a newly defined downlink RS. Further, in some embodiments, if the first signal is a newly defined downlink RS, the first signal may correspond to an antenna port of the terminal, and occupies a specific resource element (RE) in a time-frequency resource grid.

In embodiments of the disclosure, the network device may send the configuration information via a message such as system information or higher-layer signaling. That is, the configuration information may be carried in the system information, or the configuration information may be configured by a radio access control layer or an upper layer.

For example, the network device sends system information, where the system information contains the configuration information. The system information may be sent in a broadcast mode, or may be sent in a multicast mode, or may be sent in a unicast mode, which is not limited herein. For another example, the network device sends RRC signaling, where the RRC signaling contains the configuration information.

Further, in some embodiments, the configuration information is used for configuring the at least one first resource by indicating at least one of: a starting position of the first resource, the period of the first resource, or a size of the first resource.

For example, if the configuration information indicates the starting position of the first resource, the period of the first resource, and the size of the first resource, the terminal may determine the at least one first resource based on the starting position of the first resource, the period of the first resource, and the size of the first resource.

For another example, if the configuration information indicates the starting position of the first resource, the period of the first resource and the size of the first resource may be pre-defined in a protocol, or may be determined by the terminal based on some policy or algorithm, or may be indicated by the network device via other information, so that the terminal may determine the at least one first resource according to the configuration information.

The configuration information may also indicate any one or two of the starting position of the first resource, the period of the first resource, or the size of the first resource, and in this case, the rest may be determined through pre-configuration or pre-definition, which is not limited herein.

It should be noted that, in embodiments of the disclosure, the size of the first resource may include: a size of a time domain resource and/or a size of a frequency domain resource. The size of a time-domain resource may also be referred to as a time-domain length, etc, which is not limited herein.

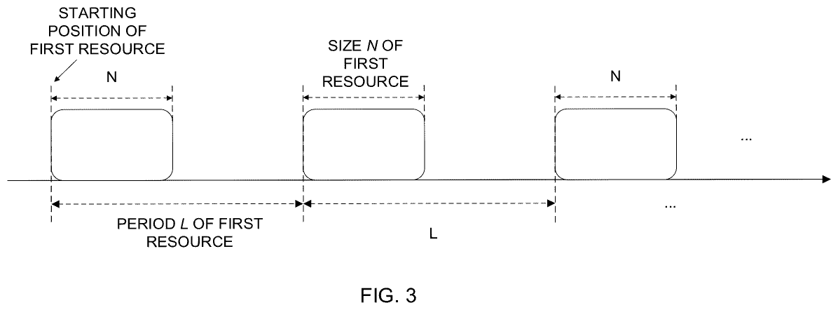

Exemplarily, as illustrated in FIG. 3, the network device sends the configuration information to the terminal via system information, RRC signaling, or higher-layer signaling. Then, the terminal determines the starting position of the first resource, the period L of the first resource, and the size N of the first resource according to the configuration information, so that the terminal receives the first signal on the periodic first resource and then obtains the signal detection result of the first signal according to the configuration information and the first signal.

In embodiments of the disclosure, the configuration information may directly indicate the starting position of the first resource, or may indirectly indicate the starting position of the first resource. For example, the configuration information may directly indicate the starting position of the first resource by indicating an absolute position of a resource. For another example, the configuration information may indicate the starting position of the first resource by indicating a relative position of the first resource. Exemplarily, the configuration information may indirectly indicate the starting position of the first resource by indicating a relative relationship between the starting position of the first resource and a starting position of a second resource, which is beneficial to improving resource utilization and flexibility of resource configuration. The relative relationship between the starting position of the first resource and the starting position of the second resource may be an offset between the starting position of the first resource and the starting position of the second resource, or may be other relationships between the starting position of the first resource and the starting position of the second resource, which is not limited herein. For instance, if the starting position of the first resource is the same as the starting position of the second resource, the offset between the starting position of the first resource and the starting position of the second resource is 0, and accordingly, the configuration information may indirectly indicate the starting position of the first resource by indicating “0”. For another instance, if the starting position of the first resource is different from the starting position of the second resource, the offset between the starting position of the first resource and the starting position of the second resource may be an integral multiple of a period of the second resource.

If the configuration information indirectly indicates the starting position of the first resource, the second resource may be any resource different from the first resource. The second resource may be periodic or aperiodic, which is not limited herein. For example, the second resource is used for carrying a second signal, and the second signal may be used for state transition of the terminal.

For example, the second signal may be an LP-WUS. In this case, if the first signal is also an LP-WUS, the first signal and the second signal are different. Specifically, the network device needs to determine, according to whether the terminal is paged, whether to send the second signal on the second resource, that is, the network device may send the second signal on the second resource or may not send the second signal on the second resource. However, in any case, the network device sends the first signal on the at least one first resource.

In some embodiments, the second resource may be configured for the terminal by the network device, or may be determined by the terminal based on some policy or algorithm. The second resource may also be pre-defined in a protocol. If the second resource is configured for the terminal by the network device, the first resource and the second resource may be configured by the network device via the same configuration information, or may be configured via different configuration information, which is not limited herein. For example, if the first resource and the second resource are configured via the same configuration information, the configuration information may indicate the second resource in addition to configuring the at least one first resource.

Further, in some embodiments, the configuration information may indicate the second resource by indicating at least one of: the starting position of the second resource, the period of the second resource, and a size of the second resource.

In addition, in embodiments of the disclosure, the configuration information may directly indicate the period of the first resource, or may indirectly indicate the period of the first resource. For example, the configuration information may directly indicate the period of the first resource by indicating an absolute value of the period. For another example, the configuration information may indicate the period of the first resource by indicating a relative relationship between the period of the first resource and the period of the second resource. The relative relationship between the period of the first resource and the period of the second resource may include a difference or ratio between the period of the first resource and the period of the second resource. Exemplarily, the period of the first resource may be an integral multiple of the period of the second resource.

Regarding the second resource, reference can be made to the elaboration related to the second resource for the case where the configuration information indirectly indicates the starting position of the first resource, which will not be described in detail again herein.

It can be understood that, in embodiments of the disclosure, the configuration information may directly indicate the size of the first resource, or may indirectly indicate the size of the first resource.

In embodiments of the disclosure, the size of the first resource may be the same as or different from the size of the second resource, which is not limited herein.

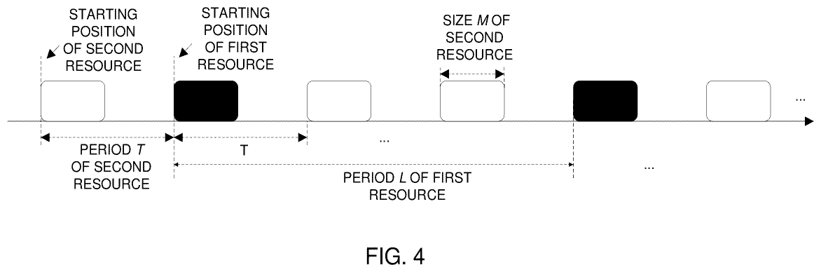

Exemplarily, the configuration information indirectly indicates the starting position of the first resource and period of the first resource. For example, as illustrated in FIG. 4, the network device sends the configuration information to the terminal via system information, RRC signaling, or higher-layer signaling. Then, the terminal determines the starting position of the second resource, the period T of the second resource, and the size M of the second resource according to the configuration information. If the offset between the starting position of the first resource and the starting position of the second resource is one time the period T of the second resource, the starting position of the first resource may be the sum of the starting position of the second resource and the period T of the second resource. Accordingly, if the period L of the first resource is three times the period T of the second resource and the size of the first resource is the same as the size of the second resource, the terminal may configure the first resource based on the second resource and a relative relationship between the second resource and the first resource, and receive the first signal on the first resource, so that the terminal can determine, according to the detection result of the first signal, whether to perform state transition and/or receive the paging related information, which is possible to ensure robustness and stability of system communication.

The implementation of receiving the paging related information by the terminal according to the signal detection result of the first signal will be described in detail below.

In some embodiments, the terminal may receive the paging related information according to the signal measurement result of the first signal as follows. The terminal receives the paging related information according to the number of first resources in the at least one first resource that satisfy a relationship between the signal measurement result of the first signal and a threshold value.

It should be noted that, the relationship between the signal measurement result of the first signal and the threshold value may be that the signal measurement result of the first signal is greater than the threshold value, or may be that the signal measurement result of the first signal is less than the threshold value.

Regarding the number of first resources in the at least one first resource that satisfy the relationship between the signal measurement result of the first signal and the threshold value, detailed elaborations will be given below with reference to several implementations.

### Implementation I

The threshold value includes a first threshold value. If the signal detection results of the first signal detected by the terminal on X consecutive first resources are less than the first threshold value and the second signal is not monitored by the terminal, the terminal receives the paging related information in a PTW.

Exemplarily, the X consecutive first resources may be understood as X first periodic resources that are consecutive in time domain (hereinafter, “consecutive periodic first resources” for short) among resources used for transmitting periodically the first signal configured by the configuration information. The resource used for transmitting periodically the first signal may refer to the at least one first resource configured by the configuration information described above. The value of X is exemplarily 3. For example, the first resource in an (i−1)^{th} period, the first resource in an i^{th} period, and the first resource in an (i+1)^{th} period are three consecutive periodic first resources in time domain, where i is a positive integer and/>1.

X and the first threshold value may be configured by the network device, or may be pre-defined in a protocol, or may be determined by the terminal based on some policy or algorithm. It should be noted that, the terminal may obtain X and the first threshold value in different manners, for example, X is configured by the network device, and the first threshold value is pre-defined in a protocol. Exemplarily, both X and the first threshold value are configured by the network device. X and the first threshold value may be configured for the terminal via the same configuration information as the first resource, or may be configured for the terminal via different configuration information than the first resource, which is not limited herein. For example, if X and the first threshold value are indicated or configured by the same configuration information as the first resource, the configuration information may indicate X and the first threshold value in addition to indicating the at least one first resource, which is more convenient for the terminal to obtain X and the first threshold value.

In some embodiments, the second signal may indicate to transition the state of the terminal. For example, the network device may carry the second signal on the second resource for transmission. Regarding the second signal and the first signal, reference can be made to the foregoing related elaborations, which will not be described in detail again herein.

In embodiments of the disclosure, in case an LP-WUS is not monitored by the terminal, if the signal detection result of the first signal is less than the first threshold value, the terminal may receive the paging related information in a PTW, which is conducive to lowering the probability that the terminal is unable to communicate normally due to skipping receiving the paging related information in case an LP-WUS cannot be monitored by the terminal. It should be noted that, if the signal detection result of the first signal is less than the first threshold value, although the network device has sent the second signal, the terminal is likely to be located in an area where the second signal cannot be monitored. Therefore, in this case, if the terminal receives the paging related information in a PTW, it can lower the probability that communication cannot be performed normally. For example, the second signal may be an LP-WUS.

In some embodiments, the network device may determine whether to send the second signal, depending on whether the terminal is paged. For example, the network device may send the second signal if the terminal is paged, or the network device may not send the second signal if the terminal is not paged.

### Implementation II

The threshold value includes a first threshold value. If the signal detection results of the first signal detected by the terminal on not less than Y first resources within a first duration are less than the first threshold value and the second signal is not monitored by the terminal, the terminal receives the paging related information in a PTW.

The total duration of the Y first resources in time domain does not exceed the first duration. If the first signal is transmitted periodically, the Y first resources may be consecutive periodic first resources in time domain; or some of the Y first resources may be consecutive periodic first resources and the rest are non-consecutive periodic first resources. Alternatively, all of the Y first resources are non-consecutive periodic first resources in time domain, which is not limited herein.

Regarding the manner for configuring Y, the first duration, and the first threshold, reference can be made to the manner for configuring X and the first threshold in implementation I, which will not be described in detail again herein. It should be noted that, the first threshold value in implementation Il and the first threshold value in implementation I may be the same threshold value, or may be different threshold values, which is not limited herein. In addition, the value of X and the value Y may be the same or different, which is not limited herein.

For example, if Y and the first duration are indicated or configured by the same configuration information as the first resource, the configuration information may indicate Y and the first duration in addition to indicating the at least one first resource, which is more convenient for the terminal to obtain Y and the first duration.

In some embodiments, the second signal may indicate to transition the state of the terminal. For example, the network device may carry the second signal on the second resource for transmission. Regarding the second signal and the first signal, reference can be made to the foregoing related elaborations, which will not be described in detail again herein.

In embodiments of the disclosure, the terminal may count the signal detection result of the first signal on the at least one first resource within the first duration. If the signal detection results of the first signal on at least Y first resources are less than the first threshold value, even if the second signal is not monitored by the terminal, the terminal still receives the paging related information a PTW, which is conducive to lowering the probability that the terminal is unable to communicate normally due to skipping receiving the paging related information in case an LP-WUS cannot be monitored by the terminal. It should be noted that, if the signal detection result of the first signal is less than the first threshold value, although the network device has sent the second signal, the terminal is likely to be located in an area where the second signal cannot be monitored. Therefore, in this case, if the terminal receives the paging related information in a PTW, it is conducive to lowering the probability that communication cannot be performed normally. For example, the second signal may be an LP-WUS.

In embodiments of the disclosure, the state of the terminal refers to a state that the terminal is in, and depends on a network service or connection state of the terminal. For example, when the terminal is in a flight mode, the terminal is disconnected from the network service. For another example, when the terminal is in a connected state, the terminal is connected to a network, etc. It should be noted that, power consumption of the terminal is usually different when the terminal is in different states.

The state of the terminal exemplarily includes a first state and a second state. State transition of the terminal may include moving out of the first state, moving to the first state, moving out of the second state, and moving to the second state. For example, the terminal moving out of the first state may include transition of the terminal to the second state from the first state. For another example, the terminal moving out of the second state includes transition of the terminal to the first state from the second state.

Exemplarily, power consumption of the terminal in the first state is lower than power consumption of the terminal in the second state.

In some embodiments, when the terminal is in the first state, the terminal may be unable to communicate normally (such as monitoring a PO, receiving a PEI, receiving paging DCI, receiving a system message, or transmitting related data) or update related parameters, but can receive the first signal or monitor the second signal, while the terminal in the second state can communicate normally or update related parameters.

For example, the first state may be a deep sleep state, a power-off state, or a flight mode. The second state may be an RRC idle state (RRC_IDLE), an RRC inactive state (RRC_INACTIVE), or an RRC connected state (RRC_CONNETED).

Taking the structure of the terminal illustrated in FIG. 1A as an example, when the terminal is in the first state, the primary communication module is in an off state while the secondary communication module is in an on state, and the terminal can receive the first signal or monitor the second signal via the secondary communication module.

Taking transition of the terminal between the first state and the second state as an example, the implementation of the terminal performing state transition of the terminal according to the signal detection result of the first signal will be introduced.

In some embodiments, the terminal may perform state transition of the terminal according to the signal measurement result of the first signal as follows. The terminal performs state transition of the terminal according to the number of first resources in the at least one first resource that satisfy a relationship between the signal measurement result of the first signal and a threshold value.

It should be noted that, the relationship between the signal measurement result of the first signal and the threshold value may be that the signal measurement result of the first signal is greater than the threshold value, or may be that the signal measurement result of the first signal is less than the threshold value.

Regarding the number of first resources in the at least one first resource that satisfy the relationship between the signal measurement result of the first signal and the threshold value, detailed elaborations will be given below with reference to several implementations.

### Implementation 1

The threshold value includes a first threshold value. When the terminal is in the first state, the terminal moves out of the first state if the signal detection results of the first signal detected by the terminal on X consecutive first resources are less than the first threshold value.

For example, when the terminal is in the first state, the terminal transitions to the second state from the first state if the signal detection results of the first signal detected on X consecutive first resources are less than the first threshold.

The value of X may be the same as or different from the value of X in Implementation I above, which is not limited herein. The value of the first threshold value may be the same as or different from the value of the first threshold value in Implementation I and Implementation II above, which is not limited herein.

For understanding of the X consecutive first resources, reference can be made to related elaborations in Implementation I above, which will not be described in detail again herein.

Regarding X and the first threshold value, reference can also be made to related elaborations in Implementation I above, which will not be described in detail again herein.

In embodiments of the disclosure, if the signal detection results of the first signal detected by the terminal on X consecutive first resources are less than the first threshold value, but the second signal is not monitored, the terminal may transition to the second state from the first state, so as to wake up the terminal, which facilitates lowering the probability that the terminal is unable to communicate normally because the terminal is unable to wake up due to the second signal being not monitored. It should be noted that, the second signal is exemplarily an LP-WUS. If the signal detection results of first signals detected by the terminal on X consecutive first resources are less than the first threshold value, the terminal is likely to be located in an area where the second signal cannot be monitored. Therefore, in this case, even if the network device has sent the second signal, the second signal cannot be monitored.

### Implementation 2

The threshold value includes a first threshold value. When the terminal is in the first state, the terminal moves out of the first state if the signal detection results of the first signal detected by the terminal on not less than Y first resources within a first duration are less than the first threshold value.

For example, when the terminal is in the first state, the terminal transitions to the second state from the first state if the signal detection results of the first signal detected on not less than Y first resources within the first duration are less than the first threshold value.

It should be noted that, the value of Y may be the same as or different from the value of Y in Implementation II above, which is not limited herein. In addition, the value of Y may be the same as or different from the value of X in Implementation 1, which is not limited herein. The value of the first threshold value may be the same as or different from the value of the first threshold value in Implementation 1, which is not limited herein.

For understanding of “not less than Y first resources within the first duration”, reference can be made to related elaborations in Implementation II, which will not be described in detail again herein.

Regarding Y, the first duration, and the first threshold, reference can be made to related elaborations in Implementation II above, which will not be described in detail again herein.

In embodiments of the disclosure, if the signal detection results of the first signal detected by the terminal on not less than Y first resources within the first duration are less than the first threshold value, but the second signal is not monitored, the terminal may transition to the second state from the first state so as to wake up the terminal, which facilitates lowering the probability that the terminal is unable to communicate normally because the terminal cannot wake up due to the second signal being not monitored.

### Implementation 3

The threshold value includes a second threshold value. When the terminal is in the second state, the terminal moves out of the second state if the signal detection results of the first signal detected by the terminal on K consecutive first resources are greater than or equal to the second threshold value.

For example, when the terminal is in the second state, the terminal transitions to the first state from the second state if the signal detection results of the first signal detected on K consecutive first resources are greater than or equal to the second threshold, which is beneficial to reducing power consumption of the terminal.

It should be noted that, the second threshold may be the same as or different from the first threshold in the foregoing implementations, which is not limited herein. The value of K may be the same as or different from the value of X and the value Y in the foregoing implementations, which is not limited herein.

In addition, regarding the K consecutive first resources, reference can be made to related elaborations of the X consecutive resources in Implementation I, which will not be described in detail again herein.

In embodiments of the disclosure, K and the second threshold value may be configured for the terminal by the network device, or may be pre-defined in a protocol, or may be determined by the terminal based on some policy or algorithm, etc. For details thereof, reference can be made to related elaborations of X and the first threshold in Implementation I, which will not be described in detail again herein.

### Implementation 4

The threshold value includes a first threshold value. When the terminal is in the second state, the terminal moves out of the second state if the signal detection results of the first signal detected by the terminal on not less than T first resources within a second duration are greater than or equal to the second threshold value.

For example, when the terminal is in the second state, the terminal transitions to the first state from the second state if the signal detection results of the first signal detected on not less than T first resources within the second duration are greater than or equal to the second threshold, which is beneficial to reducing power consumption of the terminal.

The value of T and and the value of K may be the same or different. The second duration may be the same as or different from the first duration. Specifically, T, the second duration, and the second threshold may be configured for the terminal by the network device, or may be pre-defined in a protocol, or may be determined by the terminal based on some policy or algorithm. For details thereof, reference can be made to related elaborations of X and the first threshold in Implementation I, which will not be described in detail again herein.

In addition, for understanding of “not less than T first resources in the second duration”, reference can be made to related elaborations of “not less than Y first resources within the first duration” in Implementation II, which will not be described in detail again herein.

In addition, in some other embodiments of the disclosure, the terminal may also send state change information to the network device. In this way, it is conducive for the network device to know that the state of the terminal is changed, and in particular, when the terminal is located in an area where the second signal cannot be monitored, the network device can determine or know that the state of the terminal is changed.

Exemplarily, the terminal may send the state change information to the network device after the state is changed. For example, the state change information indicates that the state of the terminal is changed or transitioned. For another example, the state change information indicates the state of the terminal after transition.

Alternatively, the terminal may send the state change information to the network device periodically. For instance, the state change information indicates whether the state of the terminal is changed. For example, if the state change information is “1”, it indicates that the state of the terminal is changed or transitioned; and if the state change information is “0”, it indicates that the state of the terminal is not changed. For another instance, the state change information indicates the state of the terminal. For example, if the terminal is transitioned to the first state, the state change information indicates the first state. For another example, if the terminal is transitioned to the second state, the state change information indicates the second state.

In some embodiments, after terminal is transitioned to the second state from the first state, that is, the terminal is woken up, if the state change information is obtained by the network device, the network device may stop sending the second signal, or may no longer send the second signal, which facilitates reducing resource overhead of a network and improving resource utilization. Alternatively, after the terminal is transitioned to the first state from the second state, if the state change information is obtained by the network device, the network device may send the second signal according to a paging state of the terminal. For example, the network device sends the second signal if the terminal is paged, and for another example, the network device does not send the second signal if the terminal is not paged.

In some embodiments of the disclosure, if the terminal has moved out of the first state, the terminal may carry the state change information in a random access preamble to send the state change information to the network device. It should be noted that, in embodiments of the disclosure, the random access preamble may be understood as message 1 (Msg1) in a random access procedure. The terminal may also send the state change information to the network device via an RRC connection request/RRC connection setup complete message or Msg3 in a random access procedure if the terminal has moved out of the first state. There is no limitation on the message carrying the state change information in embodiments of the disclosure.

Further, in some embodiments, the terminal sends the state change information to the network device if the terminal has moved out of the first state and uses an eDRX mechanism to receive a paging message.

It should be noted that, in the eDRX mechanism, the terminal monitors a PO within a PTW, where “monitoring the PO” may be understood as monitoring paging DCI at the PO.

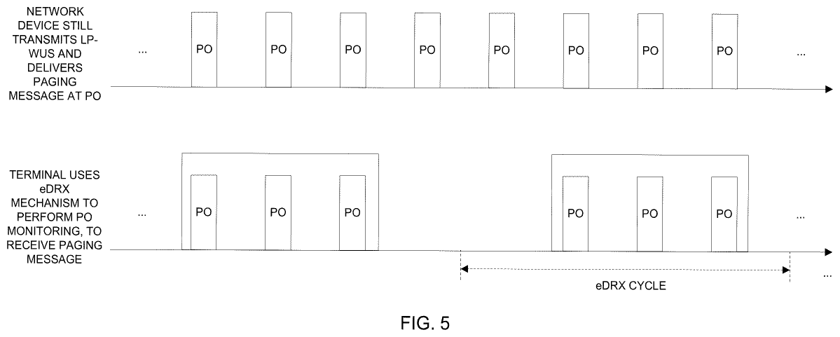

As an example, the second signal is an LP-WUS. Exemplarily, as illustrated in FIG. 5, after the state of the terminal is transitioned, the terminal may use the eDRX mechanism to perform PO monitoring (that is, the terminal can perform PO monitoring only in a PTW within an eDRX cycle) to receive a paging message, and no longer monitors the LP-WUS. Since the network device does not know that the terminal is using the eDRX mechanism to receive a paging message, the network device still sends the LP-WUS to wake up the terminal to receive the paging message, that is, after sending the LP-WUS, the network device will consistently deliver paging DCI at a PO corresponding to the terminal. However, since the terminal no longer monitors the LP-WUS, the network device is unable to use the LP-WUS to wake up the terminal to perform PO monitoring, and the terminal performs PO monitoring only in the PTW within the eDRX cycle. Therefore, for the network device, after the terminal performs state transition, if the network still sends the LP-WUS to wake up the terminal to receive the paging message, it will increase overhead at a network-device side. Therefore, the terminal may report the state change information to the network device. After the state change information is obtained by the network device, when paging the terminal, the network device will no longer page the terminal by sending the LP-WUS to wake up the terminal to receive the paging message, thereby reducing resource overhead of the network and improving resource utilization.

Alternatively, in some embodiments, if the terminal uses a DRX mechanism to receive a paging message, the terminal does not send the state change information to the network device. For example, if the terminal uses the DRX mechanism to receive a paging message after moving out of the first state, the terminal does not send the state change information to the network device even if the state of the terminal changes (for example, the terminal transitions to the second state from the first state).

It should be noted that, in the DRX mechanism, a UE needs to perform PDCCH monitoring at each PO corresponding to the UE to receive paging DCI. If the UE completes state transition and uses the DRX mechanism to receive a paging message, since the UE will perform PDCCH monitoring at each PO, even if the network uses an LP-WUS to wake up the UE to perform PDCCH monitoring at the PO, the UE will not miss the paging message delivered by the network and on the other hand, will not cause waste of network resources. Therefore, if the terminal uses the DRX mechanism to receive a paging message after moving out of the first state, the terminal does not have to send the state change information to the network device even if the state of the terminal changes (for example, the terminal transitions to the second state from the first state), which is possible to reduce power consumption of the terminal and signaling overhead.

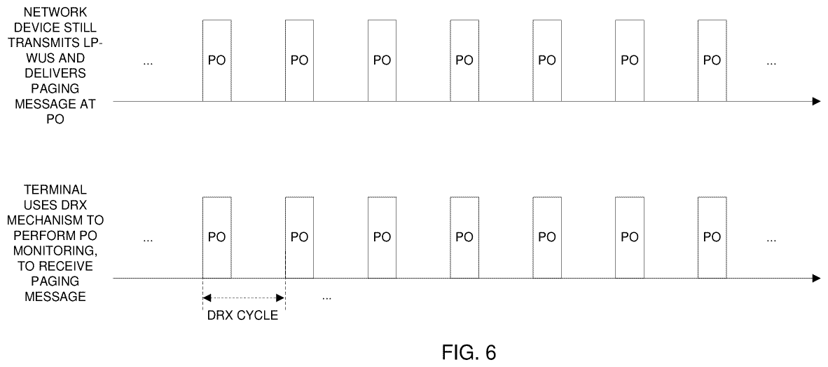

As an example, the second signal is an LP-WUS. Exemplarily, as illustrated in FIG. 6, the terminal may perform PDCCH monitoring in the DRX mechanism to receive a paging message. Although the network device does not know that the terminal is using the DRX mechanism and therefore still sends the LP-WUS to wake up the terminal to receive the paging message (that is, after sending the LP-WUS, the network will consistently deliver paging DCI at the PO corresponding to the terminal), the terminal will monitor each PO corresponding to the terminal in the DRX mechanism to obtain the paging message. Therefore, for the network device, if the terminal uses the DRX mechanism, it will not increase overhead at a network-device side, and as such, the terminal does not have to report the state change information, thereby saving network resource overhead in reporting the state change information.

The solutions in embodiments of the disclosure are introduced mainly from the perspective of method. It can be understood that, in order to implement the foregoing functions, the terminal or the network device includes corresponding hardware structures and/or software modules for executing respective functions. Those of ordinary skill in the art will appreciate that units and algorithmic operations of various examples described in connection with embodiments herein may be implemented by hardware or by a combination of hardware and computer software. Whether these functions are performed by means of hardware or hardware driven by computer software depends on the application and the design constraints of the associated technical solution. Those skilled in the art may use different methods with regard to each particular application to implement the described functionality, but such methods should not be regarded as lying beyond the scope of the disclosure.

In embodiments of the disclosure, division of functional units of the terminal or the network device may be implemented according to the foregoing method examples. For example, functional units may be divided to correspond to respective functions, or two or more functions may be integrated into one processing unit. The integrated unit may be implemented in a form of hardware, or may be implemented in a form of software program module. It should be noted that, the division of units in embodiments of the disclosure is illustrative and is only a division of logical functions, and other manners of division may also available in practice.

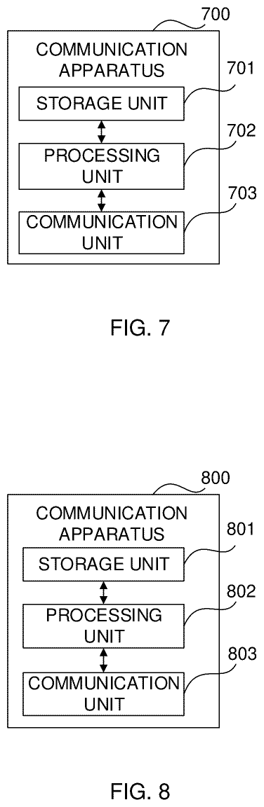

If an integrated unit is adopted, FIG. 7 is a block diagram illustrating functional units of a communication apparatus. The apparatus 700 includes a processing unit 702 and a communication unit 703. The processing unit 702 is configured to control and manage actions of the apparatus 700. For example, the processing unit 702 is configured to support the apparatus 700 to implement the steps performed by the terminal in FIG. 2, as well as other procedures in the technical solutions described in the disclosure. The communication unit 703 is configured to support communication between the apparatus 700 and other devices in a wireless communication system. The apparatus 700 may further include a storage unit 701. The storage unit 701 is configured to store program codes executed by the apparatus 700 and data to be transmitted by the apparatus 700.

It should be noted that, the apparatus 700 may be a chip or a chip module.

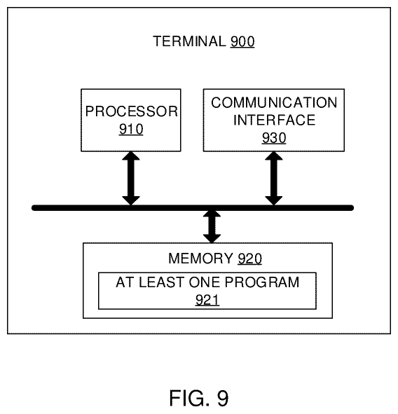

The processing unit 702 may be a processor or a controller and may be, for example, a central processing unit (CPU), a general-purpose processor, a digital signal processor (DSP), an application-specific integrated circuit (ASIC), a field programmable gate array (FPGA), or other programmable logic devices, transistor logic devices, hardware components, or any combination thereof. Various exemplary logic blocks, modules, and circuits disclosed in the disclosure can be implemented or executed. The processing unit 702 may also be a combination for implementing computing functions, for example, one or more microprocessors, a combination of DSP and microprocessor, or the like. The communication unit 703 may be a communication interface, a transceiver, a transceiver circuit, or the like, and the storage unit 701 may be a memory. If the processing unit 702 is a processor, the communication unit 703 is a communication interface, and the storage unit 701 is a memory, the apparatus 700 involved in embodiments of the disclosure may be a terminal illustrated in FIG. 9.

During implementation, the processing unit 702 is configured to perform any step executed by the terminal in the foregoing method embodiments, and when performing data transmission such as sending, the processing unit 702 may optionally invoke the communication unit 703 to complete corresponding operations. Detailed elaborations will be given below.

The processing unit 702 is configured to obtain configuration information, where the configuration information is used for configuring at least one first resource. The processing unit 702 is configured to receive a first signal on the at least one first resource, and perform state transition of the apparatus 700 and/or receive paging related information according to a signal detection result of the first signal, where the paging related information includes PEI and/or paging DCI.

It should be noted that, for the implementation of each operation in the embodiments illustrated in FIG. 7, reference can be made to the illustrations in the method embodiments illustrated in FIG. 2, which will not be described again herein.

In some embodiments, the configuration information indicates at least one of: a starting position of the first resource, a period of the first resource, or a size of the first resource.

In some embodiments, the configuration information indicating the starting position of the first resource includes: the configuration information indicating a relative relationship between the starting position of the first resource and a starting position of a second resource, where the second resource is used for carrying a second signal, and the second signal is used for state transition of the terminal.

In some embodiments, the configuration information indicating the period of the first resource includes: the configuration information indicating a relative relationship between the period of the first resource and a period of a second resource, where the second resource is used for carrying a second signal, and the second signal is used for state transition of the terminal.

In some embodiments, the configuration information further indicates at least one of: a starting position of the second resource, a period of the second resource, or a size of the second resource.

In some embodiments, in terms of receiving the paging related information according to the signal measurement result of the first signal, the processing unit 702 is configured to: receive the paging related information in a PTW, if the signal measurement results of the first signal detected on X consecutive first resources in the at least one first resource are less than a first threshold value and a second signal is not monitored, where the second signal is used for state transition of the terminal.

In some embodiments, in terms of receiving the paging related information according to the signal measurement result of the first signal, the processing unit 702 is configured to: receive the paging related information in a PTW, if the signal measurement results of the first signal detected on not less than Y first resources within a first duration in the at least one first resource are less than a first threshold value and a second signal is not monitored, wherein the second signal is used for state transition of the apparatus.

In some embodiments, the PTW is within an eDRX cycle.

In some embodiments, in terms of performing state transition of the terminal according to the signal measurement result of the first signal, the processing unit 702 is configured to: move out of a first state if the apparatus is in the first state and the signal measurement results of the first signal detected on X consecutive first resources in the at least one first resource are less than a first threshold value.

In some embodiments, in terms of performing state transition of the terminal according to the signal measurement result of the first signal, the processing unit 702 is configured to: move out of a first state if the apparatus is in the first state and the signal measurement results of the first signal detected on not less than Y first resources within a first duration in the at least one first resource are less than a first threshold value.

In some embodiments, the first state includes a deep sleep state, a power-off state, or a flight mode.

In some embodiments, the configuration information further indicates X and/or the first threshold value.

In some embodiments, the configuration information further indicates at least one of: Y, the first duration, or the first threshold value.

In some embodiments, in terms of performing state transition of the terminal according to the signal measurement result of the first signal, the processing unit 702 is configured to: move out of a second state if the apparatus is in the second state and the signal measurement results of the first signal detected on K consecutive first resources in the at least one first resource are greater than or equal to a second threshold value.

In some embodiments, in terms of performing state transition of the terminal according to the signal measurement result of the first signal, the processing unit 702 is configured to: move out of a second state if the apparatus is in the second state and the signal measurement results of the first signal detected on not less than T first resources within a second duration in the at least one first resource are greater than or equal to a second threshold value.

In some embodiments, the second state includes an RRC idle state, an RRC inactive state, or an RRC connected state.

In some embodiments, the processing unit 702 is further configured to send state change information.

In some embodiments, in terms of sending the state change information, the processing unit 702 is configured to: send a random access preamble, where the random access preamble indicates the state change information.

In some embodiments, the apparatus uses an eDRX mechanism to receive a paging message.

In some embodiments, the processing unit 702 is further configured to: not report the state change information if the apparatus uses a DRX mechanism to receive the paging message, where the state change information indicates a state of the apparatus after state transition.

If an integrated unit is adopted, FIG. 8 is a block diagram illustrating functional units of another communication apparatus. The apparatus 800 includes a processing unit 802 and a communication unit 803. The processing unit 802 is configured to control and manage actions of the apparatus 800. For example, the processing unit 802 is configured to support the apparatus 800 to implement steps performed by the network device in FIG. 2, as well as other procedures in the technical solutions described in the disclosure. The communication unit 803 is configured to support communication between the apparatus 800 and other devices in a wireless communication system. The apparatus 800 may further include a storage unit 801. The storage unit 801 is configured to store program codes executed by the apparatus 800 and data to be transmitted by the apparatus 800.

It should be noted that, the apparatus 800 may be a chip or a chip module.

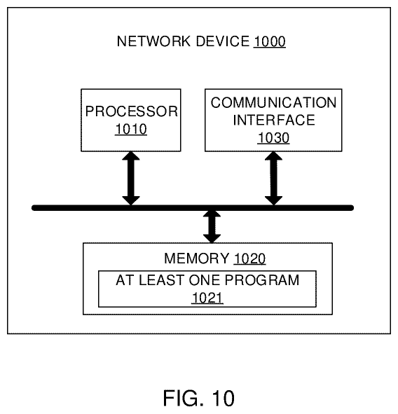

The processing unit 802 may be a processor or a controller, and may be, for example, a CPU, a DSP, an ASIC, an FPGA, or other programmable logic devices, transistor logic devices, hardware components, or any combination thereof. Various exemplary logic blocks, modules, and circuits disclosed in the disclosure can be implemented or executed. The processing unit 802 may also be a combination for implementing computing functions, for example, one or more microprocessors, a combination of DSP and microprocessor, or the like. The communication unit 803 may be a communication interface, a transceiver, a transceiver circuit, or the like, and the storage unit 801 may be a memory. If the processing unit 802 is a processor, the communication unit 803 is a communication interface, and the storage unit 801 is a memory, the apparatus 800 involved in embodiments of the disclosure may be a network device illustrated in FIG. 10.

During implementation, the processing unit 802 is configured to perform any step executed by the network device in the foregoing method embodiments, and when performing data transmission such as sending, the processing unit 802 may optionally invoke the communication unit 803 to complete corresponding operations. Detailed elaborations will be given below.

The processing unit 802 is configured to send configuration information, where the configuration information is used for configuring at least one first resource. The processing unit 802 is configured to send a first signal on the at least one first resource.

It should be noted that, for the implementation of each operation in the embodiments illustrated in FIG. 8, reference can be made to the elaborations in the method embodiments illustrated in FIG. 2, which will not be described again herein.

In some embodiments, the configuration information indicates at least one of: a starting position of the first resource, a period of the first resource, or a size of the first resource.

In some embodiments, the configuration information indicating the starting position of the first resource includes: the configuration information indicating a relative relationship between the starting position of the first resource and a starting position of a second resource, where the second resource is used for carrying a second signal, and the second signal is used for state transition of the terminal.

In some embodiments, the configuration information indicating the period of the first resource includes: the configuration information indicating a relative relationship between the period of the first resource and a period of a second resource, where the second resource is used for carrying a second signal, and the second signal is used for state transition of the terminal.

In some embodiments, the configuration information further indicates at least one of: a starting position of the second resource, a period of the second resource, or a size of the second resource.

In some embodiments, the processing unit 802 is further configured to obtain state change information.

In some embodiments, in terms of obtaining the state change information, the processing unit 802 is configured to: obtain a random access preamble, where the random access preamble indicates the state change information.

Referring to FIG. 9, FIG. 9 is a schematic structural diagram of a terminal provided in embodiments of the disclosure. The terminal 900 includes a processor 910, a memory 920, a communication interface 930, and a communication bus connecting the processor 910, the memory 920, and the communication interface 930.

The memory 920 includes, but is not limited to, a random access memory (RAM), a read-only memory (ROM), an erasable programmable ROM (EPROM), or a compact disc ROM (CD-ROM). The memory 920 is configured to store program codes executed by the terminal 900 and data to be transmitted by the terminal 900.

The communication interface 930 is configured to receive and transmit data.

The processor 910 may be one or more CPUs. If the processor 910 is a CPU, the CPU may be a single-core CPU or a multi-core CPU.

The processor 910 in the terminal 900 is configured to read at least one program 921 stored in the memory 920, to implement the following operations: obtain configuration information, where the configuration information is used for configuring at least one first resource; receive a first signal on at least one first resource; and perform state transition of the terminal 900 and/or receive paging related information according to a signal detection result of the first signal, where the paging related information includes PEI information and/or paging DCI.

It should be noted that, for the implementation of each operation, reference can be made to the corresponding elaboration in the method embodiments illustrated in FIG. 2. The terminal 900 may be configured to perform the method at the terminal side in the foregoing method embodiments of the disclosure, which will not be described again herein.

Referring to FIG. 10, FIG. 10 is a schematic structural diagram of a network device provided in embodiments of the disclosure. The network device 1000 includes a processor 1010, a memory 1020, a communication interface 1030, and a communication bus connecting the processor 1010, the memory 1020, and the communication interface 1030.

The memory 1020 includes, but is not limited to, a RAM, a ROM, an EPROM, or a CD-ROM, and is configured to store related instructions and data.

The communication interface 1030 is configured to receive and transmit data.

The processor 1010 may be one or more CPUs. If the processor 1010 is a CPU, the CPU may be a single-core CPU or a multi-core CPU.

The processor 1010 in the network device 1000 is configured to read at least one program 1021 stored in the memory 1020, to implement the following operations: send configuration information, where the configuration information is used for configuring at least one first resource; and send a first signal on the at least one first resource.

It should be noted that, for the implementation of each operation, reference can be made to the corresponding elaboration in the method embodiments illustrated in FIG. 2, and the network device 1000 may be configured to perform the method at the network device side in the foregoing method embodiments of the disclosure, which will not be described again herein.

Embodiments of the disclosure further provide a computer-readable storage medium. The computer-readable storage medium is configured to store computer programs for electronic data interchange (EDI). The computer programs are operable with a computer to perform some or all of the steps of the terminal or the management device described in the foregoing method embodiments.

Embodiments of the disclosure further provide a computer program product. The computer program product includes computer programs. The computer programs are operable with a computer to perform some or all of the steps of the terminal or the management device described in the foregoing method embodiments. The computer program product may be a software installation package.

It is to be noted that, for the sake of brevity, the foregoing embodiments are described as a series of action combinations. However, it will be appreciated by those skilled in the art that the disclosure is not limited to the sequence of actions described. According to embodiments of the disclosure, some steps may be performed in other orders or simultaneously. In addition, it will be appreciated by those skilled in the art that the embodiments described in the specification are preferable embodiments, and the actions, steps, modules, or units involved are not necessarily essential to the disclosure.

In the foregoing embodiments, the elaboration of each embodiment has its own emphasis. For the parts not described in detail in one embodiment, reference may be made to related elaborations in other embodiments.

Those skilled in the art should understand that some or all of the functions of the methods, steps, or related modules/units described in embodiments of the disclosure may be implemented through software, hardware, firmware, or any other combination thereof. When implemented by software, all or some of the functions may be implemented in the form of a computer program product, or may be implemented by a processor executing computer program instructions. The computer program product includes one or more computer program instructions, where the computer program instruction may be consist of corresponding software modules. The software module may be stored in a RAM, a flash memory, a ROM, an EPROM, an electrically EPROM (EEPROM), a register, a hard disk, a mobile hard disk, a CD-ROM, or any other form of storage medium well known in the art. The computer program instruction may be stored in a computer-readable storage medium, or transmitted from one computer-readable storage medium to another computer-readable storage medium. For example, the computer program instruction may be transmitted from one website, computer, server, or data center to another website, computer, server, or data center in a wired manner or in a wireless manner. The computer-readable storage medium may be any computer accessible usable-medium or a data storage device such as a server, a data center, or the like which integrates one or more usable media. The usable medium can be a magnetic medium (such as a soft disc, a hard disc, or a magnetic tape), an optical medium, or a semiconductor medium (such as a solid state disk (SSD)), etc.

Each module/unit in various devices or products described in the foregoing embodiments may be a software module/unit or a hardware module/unit, or some may be a software module/unit and the rest may be a hardware module/unit. For example, with regard to various devices or products applied to or integrated into a chip, various modules/units included therein may all be implemented by means of hardware such as a circuit; or at least some of the modules/units may be implemented by means of a software program run on a processor integrated in the chip, and the rest (if any) modules/units may be implemented by means of hardware such as a circuit. The same also applies to various devices or products applied to or integrated into a chip module or various devices or products applied to or integrated into a terminal.

The objectives, technical solutions, and advantages of embodiments of the disclosure are described in detail in the foregoing implementations. It should be understood that, the foregoing elaborations are merely some implementations of the embodiments of the disclosure, but are not intended to limit the protection scope of the embodiments of the disclosure. Any modifications, equivalent replacements, improvements, and the like made based on the technical solutions of the embodiments of the disclosure shall all fall within the protection scope of the embodiments of the disclosure.

1. A communication method, comprising:
obtaining configuration information, wherein the configuration information is used for configuring at least one first resource;
receiving a first signal on the at least one first resource; and
performing state transition of a terminal and/or receiving paging related information according to a signal measurement result of the first signal, wherein the paging related information comprises paging early indication (PEI) information and/or paging downlink control information (DCI).

2. The method of claim 1, wherein the configuration information indicates at least one of:
a starting position of the first resource, a period of the first resource, or a size of the first resource.

3-9. (canceled)

10. The method of claim 1, wherein performing state transition of the terminal according to the signal measurement result of the first signal comprises:
performing state transition of the terminal according to the number of first resources in the at least one first resource that satisfy a relationship between the signal measurement result of the first signal and a threshold value.

11. (canceled)

12. The method of claim 10, wherein the threshold value comprises a first threshold value, and performing state transition of the terminal according to the number of first resources in the at least one first resource that satisfy the relationship between the signal measurement result of the first signal and the threshold value comprises:
moving out of a first state, in response to the terminal being in the first state and the signal measurement results of the first signal detected by the terminal on not less than Y first resources within a first duration in the at least one first resource being less than the first threshold value.

13. The method of claim 12, wherein the first state comprises a deep sleep state, a power-off state, or a flight mode.

14-16. (canceled)

17. The method of claim 10, wherein the threshold value comprises a second threshold value, and performing state transition of the terminal according to the number of first resources in the at least one first resource that satisfy the relationship between the signal measurement result of the first signal and the threshold value comprises:
moving out of a second state, in response to the terminal being in the second state and the signal measurement results of the first signal detected by the terminal on not less than T first resources within a second duration in the at least one first resource being greater than or equal to the second threshold value.

18. The method of claim 17, wherein the second state comprises a radio resource control (RRC) idle state, an RRC inactive state, or an RRC connected state.

19-29. (canceled)

30. A terminal, comprising a processor, a communication interface, and a memory storing at least one program which, when executed by the processor, are operable with the processor to:
obtain configuration information and receive a first signal on at least one first resource via the communication interface, wherein the configuration information is used for configuring the at least one first resource; and
perform state transition of the terminal and/or receive paging related information according to a signal measurement result of the first signal, wherein the paging related information comprises paging early indication (PEI) information and/or paging downlink control information (DCI).

31. The terminal of claim 30, wherein the configuration information indicates at least one of:
a starting position of the first resource, a period of the first resource, or a size of the first resource.

32-38. (canceled)

39. The terminal of claim 30, wherein the processing unit configured to perform state transition of the terminal according to the signal measurement result of the first signal is configured to:
perform state transition of the apparatus according to the number of first resources in the at least one first resource that satisfy a relationship between the signal measurement result of the first signal and a threshold value.

40. (canceled)

41. The apparatus-terminal of claim 39, wherein the threshold comprises a first threshold, and the processing unit configured to perform state transition of the apparatus according to the number of first resources in the at least one first resource that satisfy the relationship between the signal measurement result of the first signal and the threshold value is configured to:
move out of a first state, in response to the apparatus being in the first state and the signal measurement results of the first signal detected by the apparatus on not less than Y first resources within a first duration in the at least one first resource being less than the first threshold value.

42. The terminal of claim 41, wherein the first state comprises a deep sleep state, a power-off state, or a flight mode.

43-45. (canceled)

46. The terminal of claim 39, wherein the threshold comprises a second threshold, and the processing unit configured to perform state transition of the terminal according to the number of first resources in the at least one first resource that satisfy the relationship between the signal measurement result of the first signal and the threshold value is configured to:
move out of a second state, in response to the apparatus being in the second state and the signal measurement results of the first signal detected by the apparatus on not less than T first resources within a second duration in the at least one first resource being greater than or equal to the second threshold value.

47. The terminal of claim 46, wherein the second state comprises a radio resource control (RRC) idle state, an RRC inactive state, or an RRC connected state.

48-60. (canceled)

61. A non-transitory computer-readable storage medium configured to store computer programs for electronic data interchange (EDI), wherein the computer programs, when executed, are operable to perform.

62. (canceled)

63. The non-transitory computer-readable storage medium of claim 61, wherein the configuration information indicates at least one of:
a starting position of the first resource, a period of the first resource, or a size of the first resource.

64. The non-transitory computer-readable storage medium of claim 61, wherein performing state transition of the terminal according to the signal measurement result of the first signal comprises:
performing state transition of the terminal according to the number of first resources in the at least one first resource that satisfy a relationship between the signal measurement result of the first signal and a threshold value.

65. The non-transitory computer-readable storage medium of claim 64, wherein the threshold value comprises a first threshold value, and performing state transition of the terminal according to the number of first resources in the at least one first resource that satisfy the relationship between the signal measurement result of the first signal and the threshold value comprises:
moving out of a first state, in response to the terminal being in the first state and the signal measurement results of the first signal detected by the terminal on not less than Y first resources within a first duration in the at least one first resource being less than the first threshold value.

66. The non-transitory computer-readable storage medium of claim 65, wherein the first state comprises a deep sleep state, a power-off state, or a flight mode.

67. The non-transitory computer-readable storage medium of claim 63, wherein the threshold value comprises a second threshold value, and performing state transition of the terminal according to the number of first resources in the at least one first resource that satisfy the relationship between the signal measurement result of the first signal and the threshold value comprises:
moving out of a second state, in response to the terminal being in the second state and the signal measurement results of the first signal detected by the terminal on not less than T first resources within a second duration in the at least one first resource being greater than or equal to the second threshold value.
